(19) United States
(12) Patent Application Publication
(10) Pub. No.: US 2016/0031125 A1
(43) Pub. Date: Feb. 4, 2016

(54) METHOD FOR FILLING LARGE VOLUME HOLES

(71) Applicant: Uretek USA, Inc., Tomball, TX (US)

(72) Inventor: Brent Barron, Tomball, TX (US)

(21) Appl. No.: 14/884,454

(22) Filed: Oct. 15, 2015

Related U.S. Application Data
(62) Division of application No. 13/789,112, filed on Mar. 7, 2013.
(60) Provisional application No. 61/608,449, filed on Mar. 8, 2012.

(51) Int. Cl. B29C 39/18

(52) U.S. Cl. CPC B29C 39/18; B29K 2075/00

(57) ABSTRACT

The present disclosure provides methods to fill large holes rapidly with polyurethanes by injecting polyurethanes in a plurality of containers having volumes less than the volume of the hole to be filled, letting the polyurethanes cure in the containers, and using the polyurethane-filled containers to fill the large hole. Additional filling polymers may be added in between and on top of each layer of polyurethane-filled containers.

### CROSS-REFERENCE TO RELATED APPLICATIONS

This Application is a divisional of U.S. Non-Provisional patent application Ser. No. 13/789,112 filed Mar. 7, 2013 which claims the benefit of U.S. Provisional Application 61/608,449 filed on Mar. 8, 2012, all of which are hereby incorporated by reference in their entirety.

### FIELD OF INVENTION

The present disclosure generally relates to methods for filling holes of a certain volume, and more particularly to using polyurethanes to fill holes of a certain volume.

### BACKGROUND

In the construction and maintenance of built structures, including buildings, roadway aggregates and pavements, airport runways, port authority pavements, rail and loading dock areas, and equipment supporting slabs of various designs, large voids are commonly encountered. When traditional filling materials such as aggregates, concrete mixes, asphalt mixes, or chemically stabilized soils are not readily available, often it is desirable to fill such large holes with expanding polymers such as rigid polyurethanes. A certain minimum cured in place compressive strength is often required for such polyurethane repairs in order to bear the weight of overburden of soils, structures, or vehicular traffic.

In order to perform rapid repair, fast curing time of the polyurethane polymer is critical. Curing time for rigid polyurethanes is often quoted at 15 minutes for the polymer to reach 90% of its potential compressive, tensile, shear, and elongation strength characteristics. Such short curing times are based on smaller polyurethane samples, usually no more than a few inches thick. The components of the polyurethane compositions chemically react with one another during the curing period to reach the specified properties. The exothermic heat from the chemical reaction typically adds in excess of 250 degrees Fahrenheit to the surrounding ambient temperature.

When a small amount of polyurethane polymer is used or when the volume of polymer used has a smaller cross section, the exothermic heat can dissipate into the earth, into the air, water, or surrounding structures, thereby achieving 90% of its potential properties during the quoted curing time. However, when a larger amount is used or if the volume of polymer used has a larger cross sections, like those required for large hole filling, the curing time of the polymers can be extended by hours or even days. This is because the inherent thermal insulation qualities of these polyurethanes trap the exothermic heat as the heat is generated by the chemical reactions, thereby significantly extending the curing time. This phenomenon has been a problem to overcome in using polyurethanes for large void filling applications.

### SUMMARY OF THE DISCLOSURE

In accordance with one aspect of the invention, there is provided a method which uses smaller volumes of polyurethane (expanded rigid polymer) placed into containers, such as confinement bags, to provide faster curing of the polymer material.

According to another aspect of the present disclosure, there is provided a method which places, in various configurations, these containers filled with expanded rigid polymer into larger volume holes.

In one embodiment, the method of the present disclosure further comprises filling spaces between and around these small bags with additional liquid polymer to complete the filling of a large volume hole through at least bonding of the small bags together. Polyurethane-filled spaces also improves the overall rigidity of the polyurethane mass, as well as its load-bearing capacity.

Other advantages and features will be apparent from the following detailed description when read in conjunction with the attached drawings. The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed methods and apparatuses, reference should be made to the embodiments illustrated in greater detail in the accompanying drawings, wherein:

FIG. 1 is a side view illustration of a hole filled according to one aspect of the present disclosure.

FIG. 2 is a plan view illustration of a hole filled according to one aspect of the present disclosure.

FIG. 3 is a plan view illustration of a hole filled with containers of different dimensions and shapes.

FIG. 4 is an isometric view of a container with a rigid side and an expandable side, the expandable side depicted according to one embodiment of the present disclosure as a stretchable material or in the alternative as a folded rigid or semi rigid structure.

FIG. 5 is an isometric view of a container with five non-rigid sides and one open side, according to one embodiment of the present disclosure.

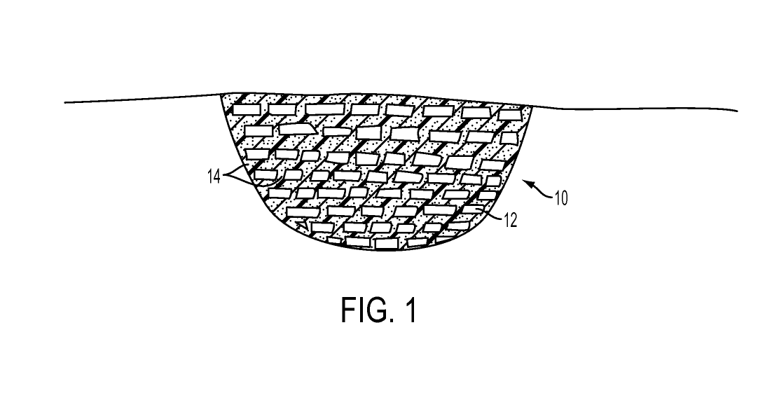

It should be understood that the drawings are not necessarily to scale and that the disclosed embodiments are sometimes illustrated diagrammatically and in partial views. For instance, representation of the areas between the containers in FIGS. 1-3 may be exaggerated to better illustrate the embodiment. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

According to one aspect of the present disclosure, there is provided a method to rapidly fill holes of a minimum volume using rigid polyurethanes or other materials that exhibit similar properties. In the preferred embodiment, the volume of the holes to be filled is at least about 8 cubic feet. In one embodiment, the preferred minimum length is about 2 feet and the preferred minimum width is about 2 feet. The holes can be of any shape, be near the surface, or be deeper in the earth.

The holes of a certain minimum volume can be filled rapidly or quickly using polyurethane by providing a faster curing time for the total volume of polyurethanes used to fill the holes. In the preferred embodiment, faster curing is achieved by filling individual containers of certain sizes with polyurethanes to form filling blocks. In one embodiment, the container is a bag which is sized to provide a desired curing time of the polyurethanes contained in the bag. For instance, a polyurethane composition that releases a higher exothermic energy may be filled in bags that are smaller in volume than a polyurethane composition that releases a lower exothermic energy.

Preferably, the containers are bags made of materials that readily accept and contain expanding polyurethane, and also quickly and efficiently dissipate heat. Exemplary materials include paper, mesh, fiberglass, polyester, textile, fabric, and other materials with similar heat dissipation properties. Both synthetic and non-synthetic textiles are contemplated, as well as mineral, plant, and animal textiles. Preferably, the bags can comprise materials used to make sandbags.

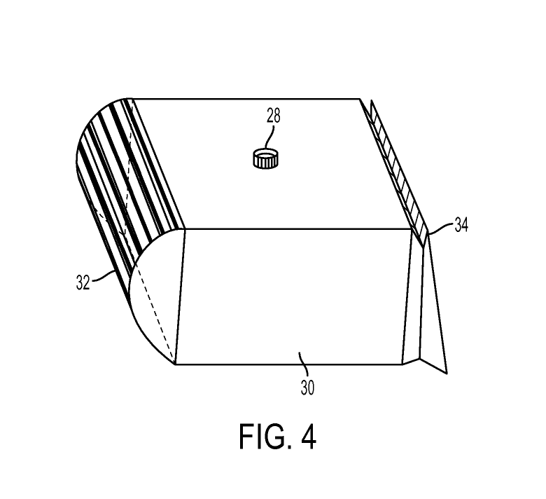

Other types of non-rigid, rigid, or partly rigid containers may be used. Preferably, the containers are fashioned, at least in part, of materials that accelerate exothermic heat dissipation by way of conduction, convection, or radiation. For example, in one embodiment characterized in FIG. 4, the container is a rectangle comprising a rigid high-conductivity material 30 such as thin metal on five sides, with an expandable flexible material 32 on the sixth side and a hole 28 on one side in which the polymer is injected. The expandable side stretches as needed to catch the overflow expansion of the expanding polymer and may be made of rubber, rubber-like material, 2-way or 4-way stretch fabrics, or any material capable of stretching to increase the volume of the container. In the alternative or in addition, one or more sides may contain folds 34 in order to allow for expanded volume of the container as needed.

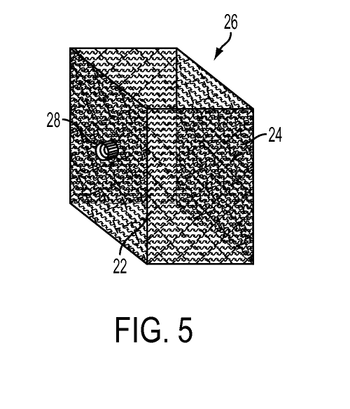

In another embodiment, a semi-rigid container comprises a rigid skeletal structure with non-rigid material in suspension around said skeletal structure, as contemplated in FIG. 5. The skeletal structure 22 may be constructed of any rigid or semi-rigid material capable of maintaining integrity at least during initial contact with the expanding polymer. The semi-rigid container may be open at one end 26 or may be enclosed, with the enclosure having a polymer injection opening 28. In one embodiment, non-rigid, heat dissipating material 24 is suspended around the skeletal structure 22 to form a shell. Examples of the non-rigid material include paper, mesh, fiberglass, polyester, textile, fabric, and other materials with similar heat dissipation properties. In some embodiments, one or more sides of non-rigid material may be substituted with rigid or partially rigid material. Expanding polymer is injected into the container until full. For a container open at one end, the injection operator gauges the correct amount of polymer such that the polymer will expand to fill the container.

The filling blocks need not be square, rectangular, or spherical. In one embodiment, the container may be uniquely shaped to dissipate heat, such as by maximizing the surface area of the container. A person skilled in the art of heat sinks would understand how to fashion a container of optimum surface area which takes into account the expansion rate, rise time gel time, and tack free time of the polymer.

In certain embodiments, the container or bag need not maintain its integrity through the expansion/injection process. The container need only affirmatively shape the expanding polymer. After the polymer is shaped into the preferred geometric mold, the container may be discarded, and the block of polymer placed into the hole.

For simple shapes, the dimensions of the containers are preferably about 12 inches×14 inches×18 inches. In another embodiment, the dimensions of the containers are preferably 14 inches×14 inches×26 inches, such as those used for making sand bags. Preferably, the containers allow the exothermic heat to dissipate to achieve the desired curing time, such as through perforations, high surface area, material that promotes convection, conductive material, or similar systems to reject heat.

The desired curing time is preferably the quoted curing time of the rigid polyurethane or other expanding polymer. In one embodiment, the desired curing time is about 15 minutes to about 20 minutes. The smaller volume of the containers in comparison with the volume of the hole to be filled, in conjunction with the exothermic heat dissipation qualities of the container materials, allows the polyurethane polymer to cure within the desired time period.

The method according to the aspects of the present disclosure further comprises using multiple filling blocks to fill the hole. In the preferred embodiment, the hole is filled layer-by-layer with multiple filling blocks, such as containers filled with cured polymer, like those shown in FIG. 1. In FIG. 1, the bottom part of hole 10 is filled with a first layer of containers 12 containing cured polymer. In the preferred embodiment, additional polyurethane 14 is added to the layer of containers 12 to fill the open space 14 between the containers and to cover the layer of containers 12. In one embodiment, the additional polyurethane completely covers the layer of containers 12 to form layer 14. Afterward, multiple additional cured polymer containers are then used to fill above that covered container layer. Additional polyurethane is then added to the open space 14 between those containers, completely covering the container layer. The process is repeated until the large hole is filled to the desired level. Individual containers 12 act as individual filling units for filling in hole 10.

The exothermic heat is dissipated more rapidly through the total surrounding surfaces of containers 12 via the natural heat sink of adjacent earth, water, or air, as compared to the heat dissipation of the same amount of polymer directly injected into the hole. The total reduction in curing time and the faster achievement of stronger physical characteristics of the polymer used is accomplished by the methods of the present disclosure.

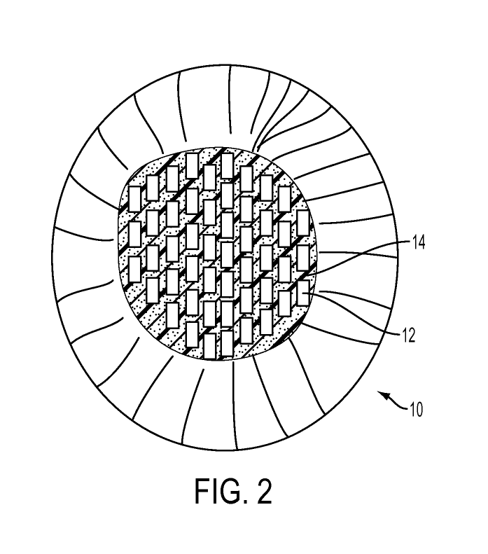

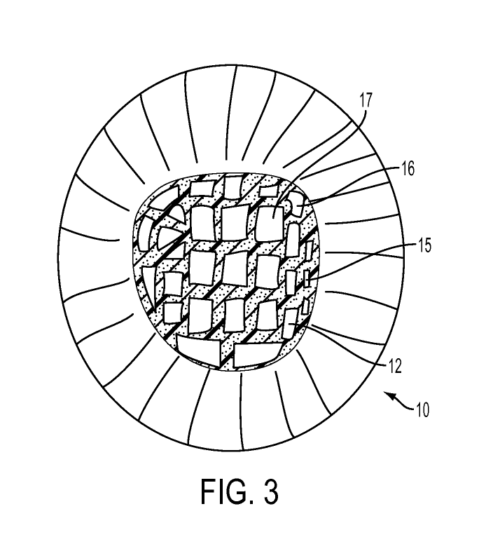

In one embodiment, containers 12 of cured polymers can be made off-site and transported to the site of the project where hole 10 is located. In another embodiment, containers 12 can be made at the site of the project where hole 10 is located, either outside of the hole or inside the hole itself. In one embodiment, containers 12 have various dimensions. FIG. 3, for instance, shows containers with smaller dimensions 15 and various shapes 16 placed at the edges of hole 10 whereas containers with larger dimensions 17 can be placed at the center of hole 10. In another embodiment, containers 12 have uniform dimensions, as in FIG. 2.

Different types of polyurethanes can be used with the method of the present disclosure. Preferably, the polyurethane exhibits compressive strengths of at least about 20 psi, more preferably at least about 30 psi, and most preferably at least about 40 psi, when cured. Hole 10 can be filled with containers 12 containing different types of polyurethanes. In one embodiment, materials with compressive strength of at least about 40 psi are used to fill containers 12 that are placed around the periphery of hole 10 while materials with compressive strengths of at least about 20 psi or at least about 30 psi are used to fill containers 12 that are placed near the center or middle of hole 10.

In one embodiment, the polyurethane comprises a two-part foam. The first component can be a mixture of polyols comprising a polyether polyol and/or a polyester polyol, a catalyst, and/or water. The water in the composition may be 3.44% by weight. The second component can be an isocyanate MDI. The mixing of these two components produces an expandable polyurethane foam the density whereof, at the end of expansion, varies according to the resistance opposed by the soil adjacent to the injection region.

In another embodiment, the chemical compositions comprise an aromatic isocyanate and a polyol resin blend. The polyol blend is formulated to provide a final rigid polyurethane foam product with a free rise density characteristic of between 5 and 10 pounds per cubic foot. The material is a two component system with a 1/1 ratio by volume. One example of such material is URETEK HRR Polyurethane manufactured by Bayer Material Science.

While polyurethane is mentioned specifically by name as the preferred choice, the use of the term “polyurethane” is not intended to be limiting, but rather exemplary. The methods of the present disclosure are applicable to other substances that exhibit similar properties as polyurethane and suffer from a similar problem of prolonged curing time in a large volume.

The method to fill any large hole with polymer, according to the present invention, substantially consists in first filling smaller containers of various selected sizes with expanded rigid polyurethane. The polyurethane in the container is then allowed to cure to at least about 90% of its fully cured physical strength characteristics for compressive, tensile, elongation, and shear strength, and then the container is placed into the hole.

In one embodiment, the container-filling process uses a liquid proportioner pump. There are a variety of types of liquid proportioner pumps known to those of ordinary skill in the art. It is within the knowledge and skills of a person of ordinary skill in the art to select an appropriate liquid proportioner pump and substance for use according to the aspects of the present disclosure.

Depending on the reaction profile characteristics (rise time, gel time, tack free time) of the substance selected, containers 12 are preferably injected with an appropriate amount of the liquid polyurethane components to provide sufficient liquid material to fill containers 12 with the cured polymer, which may have expanded substantially and have a final volume that is significantly larger than the initial starting volume in liquid form. After containers 12 are filled with polymer, and in some instances, after polymer expansion is completed, the filled containers 12 are set aside to cure, typically for a minimum of 15 to 20 minutes. For one job, the container-filling process is repeated until the total volume of the multiple expanded small containers is roughly equivalent to the volume of the large hole to be filled, e.g., hole 10. According to another aspect, the container-filling process continues to provide “pre-made” containers having already cured polymers for future use. In one embodiment, containers 12 containing cured and/or expanded polyurethane can be placed into hole 10. Containers 12 can be placed in a pattern or at random.

In one embodiment, a proportioner pump is used to add liquid polyurethane components to the stacked containers 12 to fill the space between the containers 12. The polymers can be added at random layers, in a pattern, or for each layer of containers 12, as shown as layer 14 in FIG. 1. In one embodiment, layer 14 is allowed to cure for at least about 15-20 minutes before additional containers 12 are added. As described, hole 10 is thereby filled with polyurethane without the current problem of longer polymer curing time, longer heat dissipation time, or higher likelihood of the polymer material itself to smolder because of excessive exothermic heat generation of polyurethane compositions, particularly large volumes of expanding polymers.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method of rapidly filling a hole comprising the steps of:
introducing, into a container, a polymer composition configured to harden through a chemical reaction, in which the hardened polymer composition and the container form a filling block;
allowing the polymer composition to react for an amount of time to achieve a compressive strength of at least 20 psi;
placing a plurality of filling blocks in a hole to at least partially fill the hole; and
introducing, on top of or between the plurality of filling blocks in the hole, a polymer composition configured to harden through a chemical reaction.

2. The method of claim 1, further comprising placing one or more additional filling blocks in the hole, wherein the filling block and the additional filling blocks are configured to form a layer of filling blocks.

3. The method of claim 2, further comprising the step of placing additional polymer composition on top of or between the blocks placed in the hole.

4. The method of claim 3 wherein the additional polymer composition is allowed to cure for at least about 15 minutes before adding another layer of filling blocks.

5. The method of claim 1, wherein the filling blocks are formed at a site where the hole is located.

6. The method of claim 1, wherein the polymer composition comprises a two-part polyurethane.

7. The method of claim 1, wherein the container is a bag.

8. The method of claim 1, wherein the container comprises paper, mesh, fiberglass, polyester, textile, fabric, and combinations thereof.

9. The method of claim 1, in which the container comprises an injection opening configured to receive injection of the polymer composition into the container.

10. The method of claim 1, wherein the container comprises a plurality of sides, and wherein at least one side is configured to expand the volume of the container upon injection of the polymer.
